(19) United States
(12) Patent Application Publication
(10) Pub. No.: US 2012/0160798 A1
(43) Pub. Date: Jun. 28, 2012

(54) Healthy Pour Serving Size Cap

(76) Inventor: Thomas Merlyn Acklam, Indian Trail, NC (US)

(21) Appl. No.: 12/976,301

(22) Filed: Dec. 22, 2010

(51) Int. Cl. G01F 11/26; B65D 47/00

(52) U.S. Cl. 215/228; 222/456

(57) ABSTRACT

The present invention relates to a cap that can be used in conjunction with the packaging of food products such as salad dressing sauces, condiments or other ingredients such as oils or vinegars, and more particularly to a healthy pour serving size cap that will hold the same amount of product as indicated as a “serving size” on the product's label. The serving size cap contains a top chamber, a floor, and a bottom chamber. The cap also has a lid to open or seal the top chamber. After the user squeezes the product into the top chamber, the lid can then be opened to allow the correct serving sized portion to pour out. The membrane at the floor would keep additional product from dispensing when the bottle is tipped to pour. The entire cap can be screwed off in the event that the user wants to open the bottle.

### BACKGROUND OF THE INVENTION

1. Field of the Invention

The present invention relates to a cap that can be used in conjunction with the packaging of food products such as salad dressing, sauces, condiments or ingredients such as oils, vinegars or others, and more particularly to a healthy pour serving size cap that will hold the same amount of product which is indicated as a “serving size” on the product's label.

2. Description of Related Art

The present invention is important insofar as a vast amount of the world's population is overweight and trying to lose weight by eating in a more health conscious manner such as eating salads. However, the dieting individuals often unknowingly pour too much dressing on their salads; thus, increasing the calorie counts of the meal.

Therefore a convenient means to help dieting individuals to control the intake of salads dressings or other type of condiments is needed.

Although there are container caps and lids that have measuring or containment areas that have been awarded patents as described below, they are different from my present invention.

U.S. PreGrant Publication No. 2009/0193890 A1 to Mentesh discloses a measuring cap for a bottle that may be used as a means to measure liquid or flowable contents being poured from a bottle. To use, a user need to unscrew the cap from bottle neck, inverted the cap and pours the liquid to be measured into the internal container.

U.S. PreGrant Publication No. 2007/0113920 A1 to Bronner discloses a measuring bottle cap. To use, the cap will be removed from the bottle and the fluid can be poured from the bottle into the cup to measure the amount without inverting the cap.

As can be seen in aforementioned prior art and in the following U.S. Pat. No. 7,032,632, U.S. and U.S. Pat. No. 4,416,381 there is prior art with diverse liquid dispensers. While all of the prior art constructions are adequate for the basic purpose for which they have been specifically designed, my present invention is distinguished from these prior art in that the serving size cap of my present invention does not need to be removed from the bottle to receive the product. Moreover, the serving size cap is used with the bottle that holds semi-liquid products, such as salad dressing or other condiments.

The invention here disclosed is unique due to the fact that the container area is meant to contain the specific volume of the “serving size” indicated on the product's label. My present invention has unique design that is different from the prior art. The present invention is simple and easy to use and can be manufacture at lower production cost.

### SUMMARY OF THE INVENTION

The primary object of the present invention is to provide a device that can let individuals accurately pour serving sized amounts of dressing, sauces, ingredients or other condiments.

Another object of the present invention is to provide a device that is convenient and easy to use.

A further object of the present invention is to provide a device that is simple and easy to manufacture at a low production cost.

My present invention is a healthy pour serving size cap that is used to attach to the dressing bottles. If each salad dressing container sold included my present invention as a cap, individuals could accurately pour labeled serving sized amounts of dressing, sauces, ingredients or other condiments.

In an exemplary embodiment of the present invention, there is disclosed a “healthy pour serving size” cap that can be used in conjunction with bottles of dressing sauces, ingredients or other condiments. The key differentiation of my invention from prior art is that the cap will hold the same amount of product as indicated as a “serving size” on the product's label.

The healthy pour serving size cap contains a top chamber, a floor, and a bottom chamber. The bottom chamber has an internally threaded orifice that matches with the threaded neck of a bottle so that the cap can be affixed to the bottle. The floor is located between two chambers and has a small membrane covered opening in the center, through which the user can squeeze the product into the top chamber of the cap. The floor may or may not contain a second small hole with a membrane to allow the release of air from the changer into the bottle while the product is being squeezed through the membrane into the chamber. Thus, the top chamber is also called a serving size chamber. The cap also has a lid to open or seal the top chamber. After the user squeezes the product into the top chamber, the lid could then be opened to allow the correct serving sized portion to pour out. The membrane(s) at the floor would keep additional product from dispensing when the bottle is tipped to pour. The entire cap could still be screwed off in the event that the user wanted to open the bottle.

The entire serving size cap is preferably made of clear plastic so the user can see through the size when the product has filled the “serving sized” chamber, but it could also be constructed of other transparent materials that is suitable for the purpose. It is preferred that the serving size cap comes in conjunction with the bottle and the product, so the serving size cap will hold the same amount of product as indicated as a “serving size” on the product's label. It may be reusable if chosen by a consumer. The serving size cap is preferably in a cylindrical shape but it may also be in other type of shapes. The dimensions of the cap, the internal chambers, and the lid could vary according to the dimension of bottles and the serving size of the products. The connecting means between lid and serving size chamber may be of any type of hinges or tethers. The lid may be in any type of forms, such as a flip top or a snap on.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of an embodiment of a serving size cap of the present invention that is placed on top of a bottle.

FIG. 2 is a transparent side view of an embodiment of a serving size cap of the present invention where the lip of the serving size cap is open.

### DESCRIPTION OF THE PREFERRED EMBODIMENT

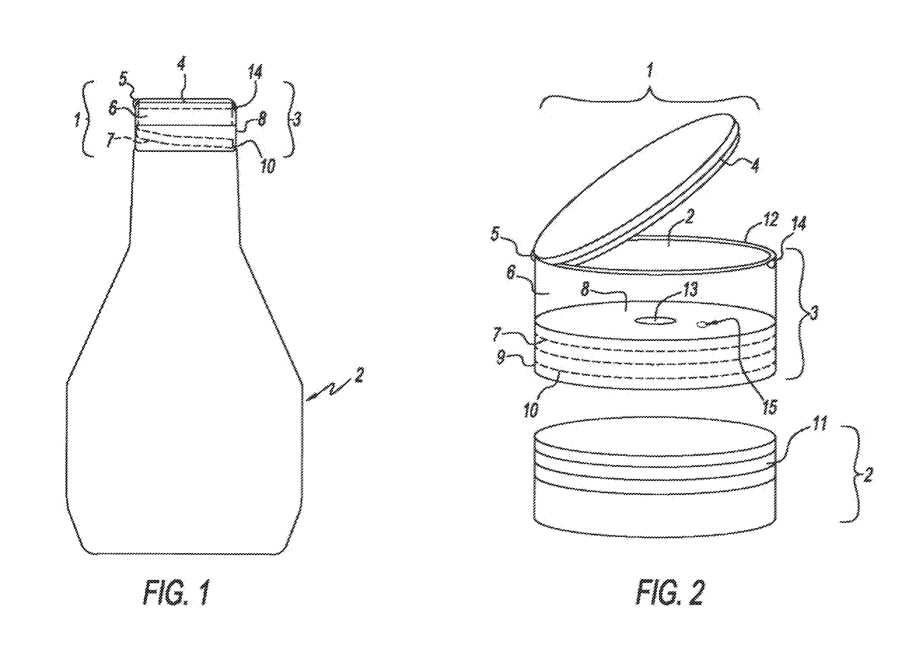

Referring to FIGS. 1 and 2, there is disclosed a serving size cap 1 that is designed to be used on top of a plastic bottle 2 that can be squeezed, such as a salad dressing bottle and other condiments bottles. Serving size cap 1 is used to provide a precise serving size of product as indicated on the product's label.

As shown in FIG. 2, the serving size cap 1 comprises a body member 3, a lid that contains a stepped floor that fits within the anti-spill lip of the upper surrounding wall of the internal chamber 4, and a connecting means 5. The body member 3 comprises surrounding walls that include an anti-spill lip 9 and an internal chamber, which is separated into a top chamber 6 and a bottom chamber 7 by a floor 8. The bottom chamber 7 surrounded by said floor 8 (on the top) and said walls has an internally threaded orifice 10 that matches with the threaded neck 11 of the bottle 2 so that cap 1 can be affixed to bottle 2. This design will also allow the user to screw off to remove the entire cap 1 if they desire to freely pour the contents from the bottle 2.

The top chamber 6 surrounded by the floor 8 (on the bottom) and the walls form an open top hollow chamber for holding a serving sized portion of the product is also called a “serving size chamber” due to its function. The lid 4 is connected with the upper rim that contains a stepped floor that fits within the anti-spill lip of the upper surrounding wall 12 of the top chamber 6 through a connecting means 5 so as to seal the top chamber 6 when shut. The stepped floor keeps the product from filling up to the top of the chamber. Thus, when the chamber is filled the product is below the top of the chamber when the lid is open.

In one embodiment, an indentation 14 on the side of the cap under the lid allows a finger to get under the lid to push the lid open. The floor 8 has one large centrally located membrane 13 and may contain one small membrane covered opening 15. The large membrane 13 will allow the product to flow into the serving size chamber 6 when the user squeezes the plastic bottle and the small membrane 15, if present, will allow trapped air to escape back into the bottle when product is being squeezed into the chamber 6 via the large membrane 13. The membranes 13, 15 will also prevent additional product dispensed from bottle 2 into the service size chamber 6 when the lid 4 is opened by the user for purposes of pouring out the serving sized portion of the product. The lid 4 can then be closed to reseal serving size chamber 6 of the cap 1. This serving size cap could also be used on “upside down” bottles such as those commonly used for ketchup. For such a purpose, the serving size cap should be in a dimension wide enough to support the weight of bottle plus the contents.

The entire serving size cap 1 is preferably made of clear plastic so the user can see through the size when the product has filled the “serving sized” chamber 6, but it could also be constructed of other transparent materials that is suitable for the purpose. The serving size cap 1 is preferably in a cylindrical shape but it may also be in other type of shapes. The dimensions of the cap 1, the internal chambers 6 and 7, and the lid 4 could vary according to the dimension of bottles and the serving size of the products. The connecting means 5 between lid 4 and serving size chamber 6 may be of any type of hinges or tethers. The lid 4 may be in any type of forms, such as a flip top or a snap on. It is preferred that the serving size cap 1 comes in conjunction with the bottle 2 and the product, so the serving size cap 1 will hold the same amount of product as indicated as a “serving size” on the product's label. It may be reusable if chosen by a consumer. In a preferred embodiment, the cap 1 is in a cylindrical shape, the connecting means 5 is a hinge and the lid 4 is a clear flip top. The serving size cap 1 may be sold separately to consumers to replace the cap that comes with the bottle of salad dressing and or other condiments or it can be used by the manufacturers as a cap for the bottle for their products. The serving size cap 1 is reusable. The serving size cap 1 is simple and easy to manufacture at a low production cost.

While there have been shown and described and pointed out the fundamental novel features of the invention as applied to the preferred embodiments, it will be understood that the foregoing is considered as illustrative only of the principles of the invention and is not intended to be exhaustive or to limit the invention to the precise forms disclosed.

Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A healthy pour serving size cap that attaches to the neck of a bottle comprising:
a body member having surrounding walls, a top chamber, a floor, and a bottom chamber, said bottom chamber defined by said surrounding walls and said floor having inner threaded orifice that can be affixed to a threaded neck of said bottle, said floor is in the middle of said two chambers, said floor having a small membrane covered opening in the center to allow the product to flow into said top chamber from said bottle, said top chamber defined by surrounding walls and said floor having an opening on top;
a lid having a stepped floor for sealing said top chamber and preventing the chamber from filling up to the top of the top chamber; and
a connecting means to connect said body member and said lid.

2. The healthy pour serving size cap of claim 1, wherein said cap is made from clear plastic so the user can see through the side when the product has filled said serving sized chamber.

3. The healthy pour serving size cap of claim 1, wherein said body member is in a cylindrical shape.

4. The healthy pour serving size cap of claim 1, wherein said lid is a clear flip top.

5. The healthy pour serving size cap of claim 1, wherein said connecting means is a hinge.

6. The healthy pour serving size cap of claim 1, wherein an indentation is located on the side of the cap under the lid to allow a finger to get under the lid to push the lid open.

7. The healthy pour serving size cap of claim 1, wherein said top chamber has a slot that is suitably designed for a user to pry off said lid from said top chamber.

8. The healthy pour serving size cap of claim 1, wherein said cap is reusable.

9. The healthy pour serving size cap of claim 1, wherein said cap can be sold separately.

10. The healthy pour serving size cap of claim 1, wherein said cap is assembled with said bottle and sold with product inside.

11. The healthy pour serving size cap of claim 1, wherein the dimension of said cap are wide enough to support the weight of bottle plus the contents when it is used in conjunction with an upside down bottle.

12. A bottle filled with a consumable product sealed with a healthy pour serving size cap according to claim 1.

13. A healthy pour serving size cap that attaches to the neck of a bottle comprising:
a cylinder having a surrounding wall, a top chamber, a floor, and a bottom chamber, said bottom chamber defined by said surrounding wall and said floor having inner threaded orifice that can be affixed to a threaded neck of a bottle, said floor is in the middle of said two chambers, said floor having a small membrane covered opening in the center to allow the product flow into said top chamber from said bottle, said top chamber defined by a surrounding wall and said floor having an opening on top;
a flip top lid for sealing said top chamber; and
a hinge connecting said cylinder and said lid.

14. The healthy pour serving size cap of claim 12, wherein an indentation is located on the side of the cap under the lid to allow a finger to get under the lid to push the lid open.

15. The healthy pour serving size cap of claim 12, wherein said top chamber has a slot that is suitably designed for a user to pry off said lid from said top chamber.

16. The healthy pour serving size cap of claim 12, wherein said cap is assembled with said bottle and sold with product inside.

17. The healthy pour serving size cap of claim 12, wherein the dimension of said cap should be wide enough to support the weight of bottle plus the contents when it is used in conjunction with an upside down bottle.
